(19) United States
(12) Patent Application Publication
(10) Pub. No.: US 2019/0057414 A1
(43) Pub. Date: Feb. 21, 2019

(54) SYSTEM AND METHOD FOR OPTIMIZED SURVEY TARGETING

(71) Applicant: Facebook, Inc., Menlo Park, CA (US)

(72) Inventors: Sean Jude Taylor, Oakland, CA (US); Christina Joan Sauper Stratton, Berkeley, CA (US); Curtiss Lee Cobb, San Francisco, CA (US)

(21) Appl. No.: 15/682,353

(22) Filed: Aug. 21, 2017

(51) Int. Cl. G06Q 30/02; G06Q 50/00

(52) U.S. Cl. CPC G06Q 30/0245; G06Q 50/01; G06Q 30/0203

(57) ABSTRACT

Methods, systems, computer-readable media, and apparatuses for optimized survey targeting are presented. In some embodiments, a system comprising one or more processors determines, for each question in a plurality of questions in a survey, a prediction indicative of a likelihood that a first user will provide a specific answer to the question and a certainty score associated with the prediction. The system may then identify, based upon the predictions and the certainty scores determined for the plurality of questions in the survey, a first subset of questions from the plurality of questions in the survey, the identifying comprising excluding one or more questions in the plurality of questions from the first subset of questions. The system may also present, a first question from the first subset of questions to the first user.

### BACKGROUND

Aspects of the disclosure relate to systems and methods for optimized survey targeting.

Online (Internet) surveys are becoming an essential research tool for a variety of research fields, including marketing, social and official statistics research. However, online surveys face a number of issues. For example, user engagement with online surveys is typically low and online surveys can often degrade the overall user experience within an online platform. For example, in the context of a social network, users of the social network who feel they are presented with surveys too often or are presented surveys with too many questions may be less likely to use the social network in the future. In addition to refusing participation, terminating surveying during the process or not answering certain questions, several other non-response patterns can be observed in online surveys, such as lurking respondents and a combination of partial and item non-response. Additionally, random surveying often results in unrepresentative samples resulting in inaccurate survey results.

### BRIEF SUMMARY

Certain embodiments are described that provide techniques for optimizing the manner in which surveys are targeted to users (e.g., survey targets) such that, compared to previous surveying techniques, more useful information can be obtained while surveying fewer users and by potentially presenting a fewer number of survey questions to a survey target. A method and system for survey optimization is described that uses a model to predict how a survey target is likely to answer presented survey questions.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method, including: determining, by a system including one or more processors, for each question in a plurality of questions in a survey, a prediction indicative of a likelihood that a first user will provide a specific answer to the question and a certainty score associated with the prediction. The method also includes identifying, by the system, based upon the predictions and the certainty scores determined for the plurality of questions in the survey, a first subset of questions from the plurality of questions in the survey, the identifying including excluding one or more questions in the plurality of questions from the first subset of questions. The method also includes presenting, by the system, a first question from the first subset of questions to the first user. Other embodiments of this aspect include corresponding computer systems, apparatus, and computer programs recorded on one or more computer storage devices, each configured to perform the actions of the methods.

Implementations may include one or more of the following features. The method where the excluding the one or more questions in the plurality of questions from the first subset of questions includes: determining, based on the prediction and the certainty score determined for a particular question in the plurality of questions, that the particular question is to be excluded from the first subset of questions to be presented to the first user. The method further including: receiving, by the system, a response provided by the first user to the first question. The method may also include in response to the received response, for each question in the plurality of questions that has not been presented to the first user, generating, by the system, an updated prediction indicative of the likelihood that the first user will provide a specific answer to the question and generating an updated certainty score associated with the updated prediction. The method further including: based on the updated predictions and updated certainty scores generated for the questions in the first subset of questions of the plurality of questions that have not been presented to the first user, identifying, by the system, a second subset of questions from the plurality of questions in the survey. The method may also include presenting, by the system, a second question from the second subset of questions to the first user. The method where the second subset of questions does not include at least one question from the first subset of questions. The method where the one or more questions in the plurality of questions excluded from the first subset of questions is now included in the second subset of questions. The method where determining a prediction and an associated certainty score for each question in the plurality of questions in the survey includes: using a model to determine the predictions and the associated certainty scores for the plurality of questions in the survey, where the model is built based upon information about the first user accessible from a social networking system. The method where the model is initially trained using historical data indicative of the first user's response to one or more questions presented to the user prior to the determining step. The method where the model is a supervised machine learning model. The method where determining the prediction and the certainty score associated with the prediction is based in part on at least one of: historical data indicative of the first user's response to one or more questions presented to the user prior to the determining step. The method may also include information identifying the first user. The method may also include demographic information associated with the first user. The method may also include information pertaining to the first user's interests; or. The method may also include information identifying the first user's connections within a social networking system. The system where the excluding the one or more questions in the plurality of questions from the first subset of questions includes: determining, based on the prediction and the certainty score determined for a particular question in the plurality of questions, that the particular question is to be excluded from the first subset of questions to be presented to the first user. The system further including: receiving, by the system, a response provided by the first user to the first question. The system may also include in response to the received response, for each question in the plurality of questions that has not been presented to the first user, generating, by the system, an updated prediction indicative of the likelihood that the first user will provide a specific answer to the question and generating an updated certainty score associated with the updated prediction. The system further including: based on the updated predictions and updated certainty scores generated for the questions in the first subset of questions of the plurality of questions that have not been presented to the first user, identifying, by the system, a second subset of questions from the plurality of questions in the survey. The system may also include presenting, by the system, a second question from the second subset of questions to the first user. The system where the second subset of questions does not include at least one question from the first subset of questions. The system where the one or more questions in the plurality of questions excluded from the first subset of questions is now included in the second subset of questions. The system where determining a prediction and an associated certainty score for each question in the plurality of questions in the survey includes: using a model to determine the predictions and the associated certainty scores for the plurality of questions in the survey, where the model is built based upon information about the first user accessible from a social networking system. The system where the model is initially trained using historical data indicative of the first user's response to one or more questions presented to the user prior to the determining step. The system where determining the prediction and the certainty score associated with the prediction is based in part on at least one of: historical data indicative of the first user's response to one or more questions presented to the user prior to the determining step. The system may also include information identifying the first user. The system may also include demographic information associated with the first user. The system may also include information pertaining to the first user's interests; or. The system may also include information identifying the first user's connections within a social networking system. Implementations of the described techniques may include hardware, a method or process, or computer software on a computer-accessible medium.

One general aspect includes a system, including: a processor; and a non-transitory computer readable medium coupled the processor, the computer readable medium including code, executable by the processor, for implementing a method including. The system also includes determining, for each question in a plurality of questions in a survey, a prediction indicative of a likelihood that a first user will provide a specific answer to the question and a certainty score associated with the prediction. The system also includes identifying, based upon the predictions and the certainty scores determined for the plurality of questions in the survey, a first subset of questions from the plurality of questions in the survey, the identifying including excluding one or more questions in the plurality of questions from the first subset of questions. The system also includes presenting a first question from the first subset of questions to the first user Other embodiments of this aspect include corresponding computer systems, apparatus, and computer programs recorded on one or more computer storage devices, each configured to perform the actions of the methods.

Implementations may include one or more of the following features. The system where the excluding the one or more questions in the plurality of questions from the first subset of questions includes: determining, based on the prediction and the certainty score determined for a particular question in the plurality of questions, that the particular question is to be excluded from the first subset of questions to be presented to the first user. The system further including: receiving, by the system, a response provided by the first user to the first question. The system may also include in response to the received response, for each question in the plurality of questions that has not been presented to the first user, generating, by the system, an updated prediction indicative of the likelihood that the first user will provide a specific answer to the question and generating an updated certainty score associated with the updated prediction. The system further including: based on the updated predictions and updated certainty scores generated for the questions in the first subset of questions of the plurality of questions that have not been presented to the first user, identifying, by the system, a second subset of questions from the plurality of questions in the survey. The system may also include presenting, by the system, a second question from the second subset of questions to the first user. The system where the second subset of questions does not include at least one question from the first subset of questions. The system where the one or more questions in the plurality of questions excluded from the first subset of questions is now included in the second subset of questions. The system where determining a prediction and an associated certainty score for each question in the plurality of questions in the survey includes: using a model to determine the predictions and the associated certainty scores for the plurality of questions in the survey, where the model is built based upon information about the first user accessible from a social networking system. The system where the model is initially trained using historical data indicative of the first user's response to one or more questions presented to the user prior to the determining step. The system where determining the prediction and the certainty score associated with the prediction is based in part on at least one of: historical data indicative of the first user's response to one or more questions presented to the user prior to the determining step. The system may also include information identifying the first user. The system may also include demographic information associated with the first user. The system may also include information pertaining to the first user's interests; or. The system may also include information identifying the first user's connections within a social networking system. Implementations of the described techniques may include hardware, a method or process, or computer software on a computer-accessible medium.

One general aspect includes one or more non-transitory computer-readable media storing computer-executable instructions that, when executed, cause one or more computing devices to: determine, for each question in a plurality of questions in a survey, a prediction indicative of a likelihood that a first user will provide a specific answer to the question and a certainty score associated with the prediction. The one or more non-transitory computer-readable media also includes identify, based upon the predictions and the certainty scores determined for the plurality of questions in the survey, a first subset of questions from the plurality of questions in the survey, the identifying including excluding one or more questions in the plurality of questions from the first subset of questions. The one or more non-transitory computer-readable media also includes present, a first question from the first subset of questions to the first user. Other embodiments of this aspect include corresponding computer systems, apparatus, and computer programs recorded on one or more computer storage devices, each configured to perform the actions of the methods.

### BRIEF DESCRIPTION OF THE DRAWINGS

Aspects of the disclosure are illustrated by way of example. In the accompanying figures, like reference numbers indicate similar elements.

FIG. 1 is a flow diagram illustrating a method for optimized survey targeting, according to some embodiments.

FIG. 2 is a block diagram illustrating a survey optimization system, according to some embodiments.

FIG. 3A illustrates a plurality of survey questions and a subset of survey questions, according to some embodiments.

FIG. 3B illustrates a first subset of questions and a second subset of questions, according to some embodiments.

FIG. 4 is a block diagram illustrating the survey optimization system 200 implemented in a Software as a Service (SaaS) model.

FIG. 5 illustrates an example of a computing system in which one or more embodiments may be implemented.

### DETAILED DESCRIPTION

Several illustrative embodiments will now be described with respect to the accompanying drawings, which form a part hereof. While particular embodiments, in which one or more aspects of the disclosure may be implemented, are described below, other embodiments may be used and various modifications may be made without departing from the scope of the disclosure or the spirit of the appended claims.

As described above, certain embodiments are described that provide techniques for optimizing the manner in which surveys are targeted to users (e.g., survey targets) such that, compared to previous surveying techniques, more useful information can be obtained while surveying fewer users and by potentially presenting a fewer number of survey questions to a survey target. A method and system for survey optimization is described that uses a model to predict how a survey target is likely to answer presented survey questions.

The model may initially be trained using historical survey data pertaining to the survey target's prior responses to one or more survey questions. The model may receive as inputs information identifying a survey target, survey target-specific data and demographics (or any information available for the survey target user including information related to the user's friends in a social networking platform), and one or more survey questions. The model may output predictions of (a) how likely a specific user will provide a specific response to a survey question, and (b) a degree of certainty associated with the prediction of (a). Based upon the output predictions and certainties, a decision may be made by the model whether or not to survey the survey target. If the decision is made to survey the survey target, then the model's outputted predictions and certainties may further used to determine which particular survey questions to present to the survey target (or which survey questions not to present to the survey target).

For example, if the model predicts for a survey question that the degree of certainty is high that the survey target will provide a specific predicted response to the question, then this question can be excluded from the survey (i.e., not presented to the survey target) as the survey target's response would not provide very informative data and the question would be wasted on the target user. On the other hand, if the model's predictions for a survey question indicate that it is unclear how the survey target will answer the question and/or the associated degree of certainty is low, then that question may be included in the survey for that survey target since the survey target's response to the question may help clear the response uncertainty and thus provide informative information sought by the survey.

Additionally, the model can be updated and further trained based upon the survey target's responses to survey questions that are presented to the user, above. Updates to the model may cause updates to the predictions made by the model previously. These updated predictions are then used by the model to determine whether to further survey the survey target, and, if so, which specific questions to present to the survey target. In this manner, a feedback learning loop is provided that enables the model and its predictions to be updated based upon survey target responses.

In some embodiments, one or more third-party vendors may use the services provided by the survey optimizer system to improve and optimize their own surveys. The services provided by the survey optimizer system may be offered under a Software as a Service (SaaS) model.

### Method for Optimized Survey Targeting

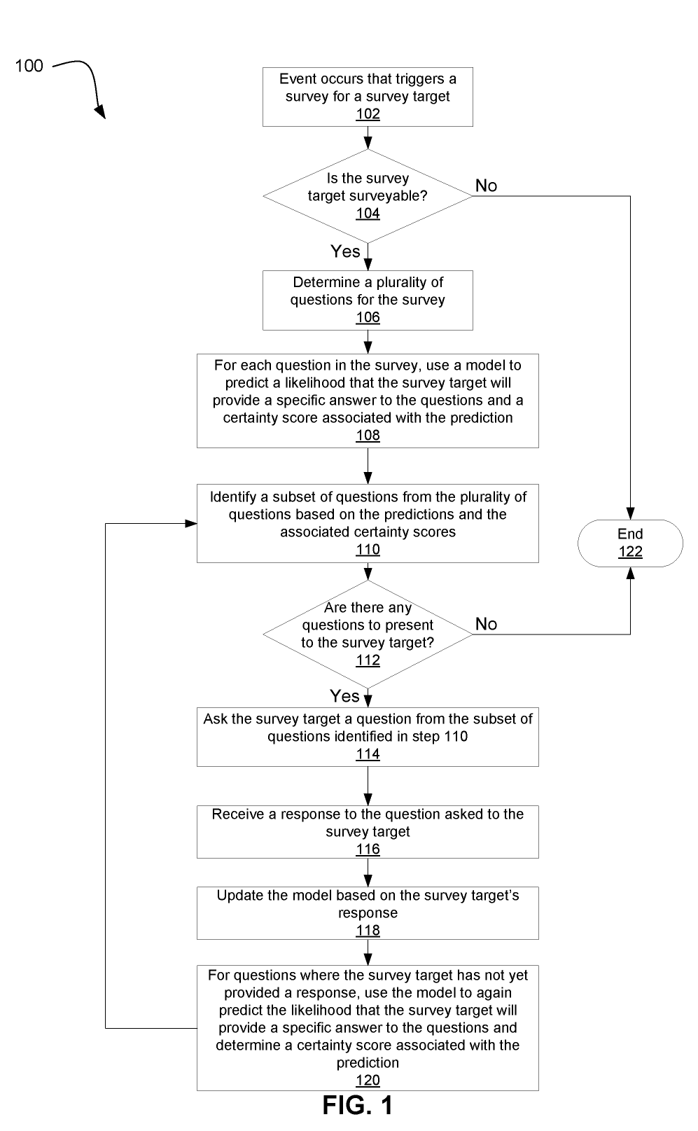

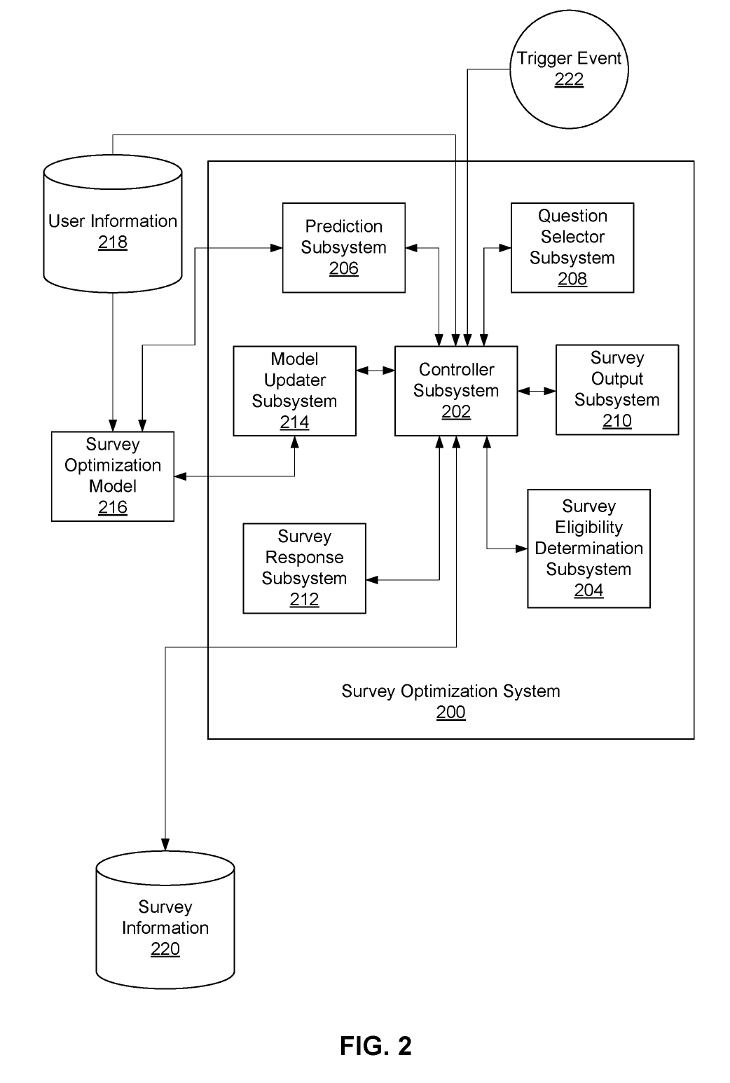

FIG. 1 is a flow diagram 100 illustrating a method for optimized survey targeting, according to some embodiments. The method may be executable by a survey optimization system 200 described in further detail with respect to FIG. 2. Further, the method may be performed within a social networking platform where one or more users (e.g., survey targets) may interact with the social networking platform via a social networking application executing on a computing device (e.g., a mobile device, personal computer, smartphone, tablet, smartwatch, set-top box etc.). During the user's interaction with the social networking platform via the social networking application, the social networking application may (e.g., via a server) present the user with a survey. The survey may be presented to the user so that the social networking platform may obtain valuable data from the user that could be used to improve the social networking platform. For example, the social networking platform may wish to survey the user regarding the user's experiences with or feelings toward the social networking platform.

At step 102, an event (e.g., trigger event) may occur that triggers a survey for a survey target. The event may be defined by the social networking platform such that when the event occurs, the survey target (e.g., user) may be presented with a survey if one or more other criteria are met. In one example, a trigger event may occur when the user opens the social networking application on his/her computing device and accesses the social networking platform after a certain period of time since the user's last interaction with the social networking application. In another example, a trigger event may occur when the user navigates to a certain page within the social networking application. In yet another example, a trigger event may occur when has been active on the social networking application for a certain period of time. In yet another example, a trigger event may occur when the user indicates that he/she wants to participate in a survey. In yet another example, a trigger event may occur at a certain time of day. In yet another example, a trigger event may occur after a certain time period after the user last completed a survey (e.g., six months after previously completing a survey). It can be appreciated that a trigger event may occur in many other situations as defined by the social networking platform.

At step 104, after a trigger event occurs that triggers a survey for a survey target, a determination is made whether the survey target is surveyable. In other words, a determination is made as to whether the survey target is eligible for the survey. Eligibility of the survey target may be determined based on one or more criteria. The criteria may include, but is not limited to, whether to survey target is from a specific location (e.g., country), whether the survey target posts certain types of content to the social networking platform (e.g., live videos), whether the survey target is in a desired target population, whether the survey target meets certain eligibility requirements, whether the survey target is a certain gender or within a certain age group, how many times or how often the survey target has been surveyed in the past, etc. For example, if information regarding how users between the ages of 20-25 feel toward the social networking platform within the context of trust is desired, the eligibility requirement may be that the survey target falls within the 20-25 age group. The survey eligibility of the survey target may be determined in real-time after the trigger event occurs that triggers the survey for the survey target. If a determination is made that the survey target is eligible for the survey, the method may continue to step 106, otherwise the method may continue to step 122 and the method may end.

At step 106, after a determination is made that the survey target is eligible for the survey, a plurality of questions for the survey may be determined. The plurality of questions for the survey may be determined based on the information desired from the survey target. For example, if the information desired from the survey target pertains to the survey target's feelings toward the social networking platform within the context of trust, the determined survey questions may include questions pertaining to how the survey target feels about the social networking platform, whether the survey target trusts the social networking platform, whether the survey target would recommend the social networking platform to others, etc. Additionally, general survey questions that may not necessarily pertain to the trust context may also be determined. In some embodiments, the survey questions may be a random assortment of survey questions that do not necessarily pertain to a particular topic. The survey questions may be retrieved from a survey information database comprising many potential questions that may be used for a survey.

At step 108, after a plurality of questions for the survey is determined, a model may be used to predict a likelihood that the survey target will provide a specific answer to the questions determined in step 106 and a certainty score associated with the prediction. The model may receive as inputs information identifying the survey target, survey target-specific data and demographic information (or any information available for the survey target user including information related to the user's friends within the social networking platform), and the survey questions determined in step 106. The model may output predictions of (a) how likely the survey target will provide a specific response to each survey question determined in step 106, and (b) a degree of certainty associated with the prediction of (a). The model may be a “black-box” model that can be used to predict responses to survey questions for any number of survey targets given information known about the survey target.

For example, if a survey question is “Do you trust our social networking platform?” and the information/data available about the survey target indicates that the survey target often makes posts on the social networking platform about the lack of online privacy, the model may be predict that the survey target will provide an answer to the survey question indicating that the user does not trust the social networking platform. For example, if the possible responses to the question are a sliding scale between 1-5, with “1” indicating the survey target does not trust the social networking platform at all and “5” indicating that the survey target definitely trusts the social networking platform, the model may predict that the survey target will provide a response of “1.” Additionally, the model may determine a certainty score associated with the prediction. In this example, based on the survey target's prior posts on the social networking platform, the model may be extremely confident that the survey target will provide a response of “1,” and thus the model may determine a certainty score of ±0.01 which may indicate that there is not much uncertainty in the predicted response.

In another example, if the survey target's prior posts are indicative of the survey target having marginal distrust in the social networking platform, the model may predict that survey target will provide a response of “2” indicating that the survey target somewhat distrusts the social networking platform. However, due to the survey target's prior posts indicating only marginal distrust with the social networking platform, there may be a chance that the survey target could also provide a response of “1” or “3” to the survey question. Accordingly, the model may determine a determine a certainty score of ±1, which may indicate that there is some uncertainty in the predicted response. A high certainty score may be indicated by a low ±value while a low certainty score may be indicated by a high ±value. The ±value may indicate a range of variation in the predicted response. For example, if a predicted response to a survey question is “2” with a certainty score of ±1, the survey target may also be likely to provide either a “1” or “3” in response to the survey question. In some embodiments, the certainty scores may also be expressed in percentages.

The predicted responses and associated certainty scores may be determined for each question in the plurality of questions for the survey determined in step 106.

At step 110, after the model predicts a likelihood that the survey target will provide a specific answer to the questions determined in step 106 and a certainty score associated with the prediction, a subset of questions may be identified from the plurality of questions determined in step 106 based on the predictions and the associated certainty scores determined in step 108. The subset of questions may exclude at least one question from the plurality of questions determined in step 106. Based on the predictions and the associated certainty scores, it may be of no value to present a question to a survey target where there is a high certainty score associated with the predicted response for that question because it may not provide any information that the model is not already relatively certain of. Accordingly, the subset of questions identified in this step may not include questions from the plurality of survey questions that have a high certainty score associated with their predicted responses. In some embodiments, a threshold certainty score may be set such that questions having predicted responses associated with certainty scores above a certain threshold may be excluded from the plurality of questions to form the subset of questions.

At step 112, after the subset of questions are identified from the plurality of questions determined in step 106 based on the predictions and the associated certainty scores determined in step 108, the survey optimization system may determine whether there are any questions to present to the survey target. In other words, the survey optimization system may determine whether the subset of questions identified in step 110 includes at least one question. If there are no questions to be asked to the survey target, the method may continue to step 122 and end. Otherwise, if there is at least one question in the subset of questions to be presented to the survey target, the method may continue to step 114.

At step 114, the survey optimization system may present the survey target with a question from the subset of questions identified in step 108. The question may be presented to the survey target via a user interface of a social networking application executing on the survey target's device (e.g., personal computer, smartphone, tablet, smartwatch, set-top box, etc.).

At step 116, after the survey target is presented with a question from the subset of questions identified in step 108, a response to the question asked to the survey target may be received from the survey target. For example, the survey target may select a “1” “2” “3” “4” or “5” in response to the question presented to the survey target. In another example, a survey target may select a response from a drop-down menu. In another example, a survey target may select between a “yes” or a “no” response. In another example, the survey target may select a response from a list of responses containing responses phrases. The survey target may select the desired response via the user interface of the social networking application.

At step 118, after the response to the question asked to the survey target is received from the survey target, the survey optimization system may update the model based on the survey target's response. The model may be updated such that a “feedback” loop is created. In other words, after a survey response is received for a survey question presented to the survey target, the survey target's response may be used to update the model with information obtained from the survey response. For example, if the survey target indicates in the survey response that he somewhat distrusts the social networking platform, the model may be updated with this information so that the model can reevaluate the next questions being presented to the survey target.

At step 120, after the model is updated based on the survey target's response, the model may be used again to predict the likelihood that the survey target will provide a specific answer to questions where the survey target has not yet provided a response, and determine a certainty score associated with the prediction. For example, after the model is updated in step 118, the model may again predict the survey target's responses for each question in the plurality of survey questions that the user has not yet answered, along with determining a certainty score associated with the prediction. The model is run again by the survey optimization system because the survey target's response to a question may change the initial predictions made and determined certainty scores in step 108. For example, if the survey question asks the survey target to respond between “1-5” on whether the survey target trusts the social networking platform, the survey target may provide a response of “1” indicating that the survey target does not trust to the social networking platform. If the next question in the subset of questions determined in step 110 is a question asking the survey target how much the survey target values online privacy, it may be quite likely that the survey target puts a lot of value on online privacy based on the survey target's previous response that he does not trust the social networking platform. Accordingly, the predicted response for the question regarding online privacy may be “5”, indicating that the survey target places a lot of value on online privacy. Further, the associated certainty score with this prediction could be ±0.2, indicating that the model is fairly certain of this predicted response. After the model is used to again predict the survey responses to the remaining survey questions and determine the associated certainty scores with the predictions, the method may revert back to step 110.

Referring again to step 110, after the model is used to again predict the survey responses to the remaining survey questions and determine the associated certainty scores with the predictions, the method may again identify another subset of questions from the remaining plurality of questions in the survey. This second subset may include all of the questions from the initial subset except for the survey question that the survey target already provided a response to, or could contain even less questions if some of the remaining questions in the survey would not be of much value to ask the survey target based on the survey target's previous responses For example, referring back to the question regarding online privacy mentioned with respect to the description of step 120, it may not be of much value to ask this question to the user given the predicted response of “1” and the certainty score of ±0.2, indicating that the model is fairly certain of this predicted response. By not asking a question that would not provide much valuable information to the survey optimization system may result in a shorter survey and improved user experience for the survey target. Additionally, the survey target may be more likely to complete the rest of the survey.

### Survey Optimization System

FIG. 2 is a block diagram illustrating a survey optimization system 200, according to some embodiments. The survey optimization system 200 includes a controller subsystem 202, survey eligibility determination subsystem 204, prediction subsystem 206, question selector subsystem 208, survey output subsystem 210, survey response subsystem 212, and model updater subsystem 214. The survey eligibility determination subsystem 204, prediction subsystem 206, question selector subsystem 208, survey output subsystem 210, survey response subsystem 212, and model updater subsystem 214 may all be communicatively coupled to the controller subsystem 202.

The controller subsystem 202 may include any general-purpose processor operable to carry out instructions on the survey optimization system 200. The controller subsystem 202 may, via the processor, execute the various applications and subsystems that are part of the survey optimization system 200.

The survey eligibility determination subsystem 204 may, when executed by the controller subsystem 202, determine eligibility of a survey target to be presented with a survey. The survey eligibility determination subsystem 204 may make this determination upon a trigger event 222 being received by the controller subsystem 202. As described above, the trigger event 222 may be defined by the social networking platform such that when the event occurs, the survey target (e.g., user) may be presented with a survey if one or more other criteria are met. The survey eligibility determination subsystem 204 may determine survey eligibility of the survey target based on one or more criteria. The criteria may include, but is not limited to, whether to survey target is from a specific location (e.g., country), whether the survey target posts certain types of content to the social networking platform (e.g., live videos), whether the survey target is in a desired target population, whether the survey target meets certain eligibility requirements, whether the survey target is a certain gender or within a certain age group, how many times or how often the survey target has been surveyed in the past, etc.

The prediction subsystem 206 may, when executed by the controller subsystem 202, predict a response by the survey target to a plurality of survey questions and determine a certainty score associated with the prediction. The plurality of survey questions may be stored in a survey information database 220. The prediction subsystem 206 may access the survey information database 220, via controller subsystem 202, to make the predictions and determine the associated certainty scores for a plurality of questions stored in the survey information database 220. The plurality of questions accessed from the survey information database 220 may be questions that could be presented to the survey target in a survey. In order to make the predictions and determine the associated certainty scores, the prediction subsystem 206 may provide the plurality of questions accessed from the survey information database 220 to the survey optimization model 216. The survey optimization model 216 may then return results after the model is run back to the prediction subsystem 206. Details of the survey optimization model 216 are described in further detail below.

The question selector subsystem 208 may, when executed by controller subsystem 202, identify a subset of questions from the plurality of questions accessed from the survey information database 220. The question selector subsystem 208 may identify the subset of questions from the plurality of questions based on the predicted responses to the plurality of questions and the associated certainty scores determined by the prediction subsystem 206. The subset of questions may exclude at least one question from the plurality of questions for the survey accessed from the survey information database 220. Based on the predictions and the associated certainty scores, it may be of no value to present a question to a survey target where there is a high certainty score associated with the predicted response for that question because it may not provide any information that the model is not already relatively certain of. Accordingly, the subset of questions identified by the question selector subsystem 208 may not include questions from the plurality of survey questions that have a high certainty score (e.g., low ±value) associated with their predicted responses.

The survey output subsystem 210 may, when executed by controller subsystem 202, output questions from the subset of question determined by the question selector subsystem 208 to a survey target. The survey output subsystem 210 may provide a question from the subset of questions to a social networking application executing on a survey target's device for presentation to the survey target via a user interface of the social networking application. In some embodiments, the survey output subsystem 210 may output one question from the subset of questions at a time, waiting for a response to the question from the survey target prior to outputting the next question.

The survey response subsystem 212 may, when executed by controller subsystem 202, receive a survey response from a survey target to a survey question from the subset of questions outputted to the survey target by the survey output subsystem 210. The survey response to the survey question may be transmitted to the survey optimization system 200, via the survey response subsystem 212, by a social networking application executing on the survey target's device.

The model updater subsystem 214 may, when executed by controller subsystem 202, update the survey optimization model 216 based on the received survey response by the survey response subsystem 212. As described above, the model may be updated such that a “feedback” loop is created. In other words, after a survey response is received for a survey question presented to the survey target, the survey target's response may be used to update the model with information obtained from the survey response.

The survey optimization model 216 may be a model configured to receive as inputs information pertaining to the survey target, survey target-specific data and demographic information (or any information available for the survey target user including information related to the survey target user's friends within the social networking platform), and the survey questions accessed from the survey information database 220. The survey optimization model 216 may receive the survey target information described above from a user information database 218, via an instruction from the controller subsystem 202. The survey optimization model 216 may receive the survey questions accessed from the survey information database 220 via the prediction subsystem 206. The survey optimization model 216 may output predictions of (a) how likely the survey target will provide a specific response to each survey question accessed from the survey information database 220, and (b) a degree of certainty associated with the prediction of (a). The survey optimization model 216 may be a “black-box” model that can be used to predict responses to survey questions for any number of survey targets within the social networking platform given information known about the survey target or the survey target's connections.

In some embodiments, the survey optimization model 216 may be a supervised machine learning model. The survey optimization model 216 may be trained using supervised machine learning techniques. The training data may include historical data indicative about the survey target's (e.g., users) prior survey responses to one or more survey questions. The survey optimization model 216 may initially be trained using this data and then the model may later be updated based on future survey responses provided by the survey target to survey questions by the model updater subsystem 214, as described above.

In some embodiments, the survey optimization model 216 may function based on a rules-based algorithm. The rules-based algorithm may define the outputs from the survey optimization model 216 based on the inputs given to the model. For example, the survey optimization model 216 may receive as inputs the information pertaining to the survey target, as described above, and a survey question. The survey optimization model 216 may then output a predicted response to the survey question and a certainty score associated with the prediction. The survey optimization model 216 based on the rules-based algorithm may also initially be trained using historical data indicative about the survey target's (e.g., users) prior survey responses to one or more survey questions.

In some cases, the survey optimization model 216 may receive as an input a survey question for which a predicted response may not be able to be predicted due to a lack of data needed to make the prediction. For example, the survey optimization model 216 may receive as an input a “brand-new” survey question which has never been asked to any survey target in the past. In this case, the survey optimization model 216 may predict an equal likelihood of each possible survey response.

The following illustrative example further exemplifies the function of the survey optimization system 200 and the various other elements in FIG. 2. Upon interacting with a social networking application executing on a survey target's (e.g., user's) device, a trigger event 222 may occur. The trigger event 222 may be defined by the social networking platform, as described with respect to FIG. 1. For example, the trigger event 222 may occur when the user navigates to a certain page within the social networking application. The controller subsystem 202 may recognize the trigger event 222.

After the trigger event 222 occurs, the controller subsystem 202 may instruct the survey eligibility determination subsystem 204 to determine whether the survey target is eligible for a survey. Survey eligibility may be determined on a number of criteria which are described with respect to FIG. 1. For example, the criteria may include, but is not limited to, whether to survey target is from a specific location (e.g., country), whether the survey target posts certain types of content to the social networking platform (e.g., live videos), whether the survey target is in a desired target population, whether the survey target meets certain eligibility requirements, whether the survey target is a certain gender or within a certain age group, how many times or how often the survey target has been surveyed in the past, etc. In this example, the survey target may reside within Canada and the social networking platform may wish to survey users from Canada who have not been surveyed in the past six months. Accordingly, assuming that the survey target has not been surveyed in the past six months, the survey eligibility determination subsystem 204 may determine that the survey target is eligible for a survey.

After the survey eligibility determination subsystem 204 determines that the survey target is eligible for a survey, the prediction subsystem 206 may access, via controller subsystem 202, the survey information database 220 in order to obtain a plurality of survey questions to potentially present to the survey target. In some embodiments, the questions within the survey information may be grouped by a topic, may be arranged in order by a question identifier associated with each question, or may be stored according to any other database hierarchy. In this example, the social networking platform may want to survey users from Canada regarding which types of content they are the most interested within the social networking platform. Accordingly, the prediction subsystem 206 may obtain questions related to content interest from the survey information database 220.

After the prediction subsystem 206 obtains the plurality of survey questions from the survey information database 220, the prediction subsystem 206 may provide the plurality of survey questions as an input to the survey optimization model 216. The controller subsystem 202 may also instruct the survey optimization model 216 to access the user information database 218 to retrieve user information associated with the survey target. The user information associated with the survey target from the user information database 218 may also be used as an input to the survey optimization model 216. In some embodiments, the controller subsystem 202 may access the user information database 218 to obtain the user information associated with the survey target and then provide the obtained user information associated with the survey target to the survey optimization model 216.

After the prediction subsystem 206 and the controller subsystem 202 provide the relevant inputs to the survey optimization model 216, the controller subsystem 202 may execute the survey optimization model 216 with the above mentioned inputs. Upon execution of the survey optimization model 216, the survey optimization model 216 may output a predicted response for the questions in the subset of questions and a certainty score associated with the predicted responses based on the provided inputs. For example, the user information associated with the survey target may be indicative of the survey target viewing “live videos” within the social networking platform multiple times a day, and may be further indicative of the survey target's friends or connections with the social networking platform also consistently viewing “live videos” within the social networking platform. Accordingly, if one of the plurality of survey questions provided as an input to the survey optimization model 216 is “How do you feel about live videos?”, the response predicted for this question by the survey optimization model 216 may be “5,” where a “5” response indicates the survey target very much liking “live videos” and a “1” response indicates the survey target very much disliking “live videos.” Further, the survey optimization model 216 may determine a certainty score of ±0.3 (low ±value), which may indicate that the survey optimization model 216 is highly certain that predicted response is correct.

After the prediction subsystem 206 accesses the survey information database 220 to obtain a plurality of survey questions, the question selector subsystem 208 may identify a subset of questions from the plurality of survey questions. The subset of questions may exclude at least one question from the plurality of survey questions. The excluded questions from the plurality of survey questions may be excluded because presenting those questions to the user may not provide a valuable response, or provide any information that is not already known. For example, the survey optimization model 216 predicted that the survey target would answer “5” to the question above, given his/her consistent viewing of “live videos.” Asking the survey target how the survey target feels about live videos would not add much value to the survey because the survey optimization model 216 is confident of the survey target's response to such a question. By including this question in the survey, the survey would be unnecessarily more lengthy and also runs the risk of termination by the survey target and a frustrated user experience. Accordingly, the question selector subsystem 208 may exclude this question from the subset of questions of the plurality of survey questions.

After the question selector subsystem 208 identifies a subset of questions of the plurality of survey questions, the survey output subsystem 210 may present a question from the subset of questions to the user. For example, the survey output subsystem 210 may present a first question of the subset of questions to the survey target, or may present a random question from the subset of questions to the survey target. The survey output subsystem 210 may present the question to the survey target via a user interface of a social networking application executing on the survey target's device. The survey target may be presented with, via the user interface, the survey question and a number of possible responses to the survey question. In this example, the survey output subsystem 210 may present the survey target with the following question: “How often do you play GIFs on the social networking platform?” The survey output subsystem 210 may also present the survey target with the following possible survey responses to the survey question: “1”—never; “2”—rarely; “3”—on occasion; “4”—regularly; “5”—all the time. This question may be presented to the survey target because the survey optimization model 216 may not be confident or certain in the survey target's predicted response. In other words, when the survey optimization model 216 predicted the survey target's response to this question, the certainty score may have been low (high ±value).

After the survey output subsystem 210 presents the question above to the survey target, the survey response subsystem 212 may receive a response to the survey question from the survey target. The response may be received from the social networking application executing on the survey target's device. For example, the survey response subsystem 212 may receive a “2” response from the survey target.

After the survey response subsystem 212 receives a response to the survey question from the survey target, the model updater subsystem 214 may update the survey optimization model 216 based on the received response to the survey question. For example, if the user provided a “2” response to the survey question above, indicating that the user rarely plays GIFs on the social networking platform, the survey optimization model 216 may be updated with this information. By updating the model with the information from a received survey response, a “feedback loop” is established which may make the survey optimization model 216 more accurate upon each subsequent response. In other words, the survey optimization model 216 may be able to better predict responses to future survey questions based on received survey responses. For example, based on the “2” response received from the user, the survey optimization model may be able to better predict a survey response to a question asking the survey target whether the survey target likes images with sounds. Since the survey target indicated that the survey target rarely plays GIFs on the social networking platform, the survey optimization model 216, after being updated, may be able to predict that the survey target would response to the question about whether the survey target likes images without sounds with a response indicating that the user does not like such content.

After the model updater subsystem 214 updates the survey optimization model 216 with the received survey response, the controller subsystem 202 may again execute the survey optimization model 216 for the plurality of survey questions obtained by the prediction subsystem 206 from the survey information database 220. The survey optimization model 216 is executed again because the survey target's response to the prior survey question may change the predictions and/or associated certainty scores for the remaining unanswered questions in the survey.

After the survey output subsystem 210 presents a question from the subset of questions to the survey target, the question selector subsystem 208 may again select another subset of questions from the unanswered questions based on the predicted responses and associated certainty scores output by the survey optimization model 216. For example, the subset of questions may now no longer include a question regarding whether the survey target likes images without sounds. A question from this subset of questions may then be presented to the survey target, and the process outlined above may repeat with the model being updated again with the survey target's response to this question.

### Determining Subsets of Survey Questions

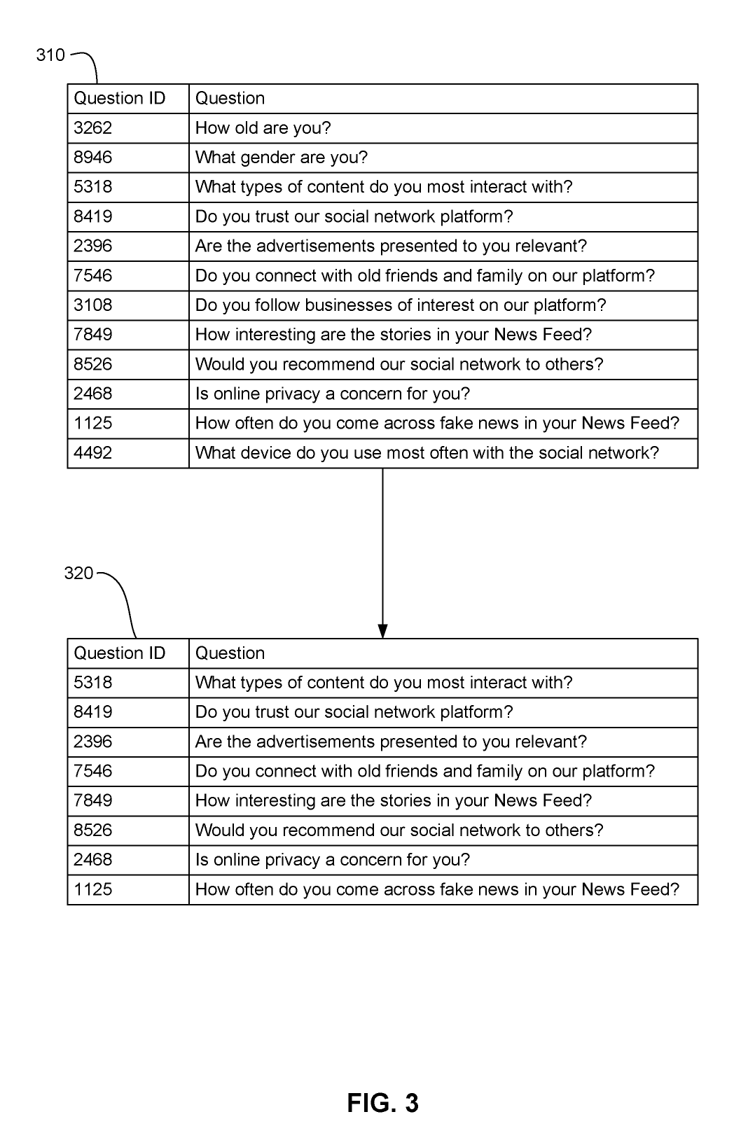

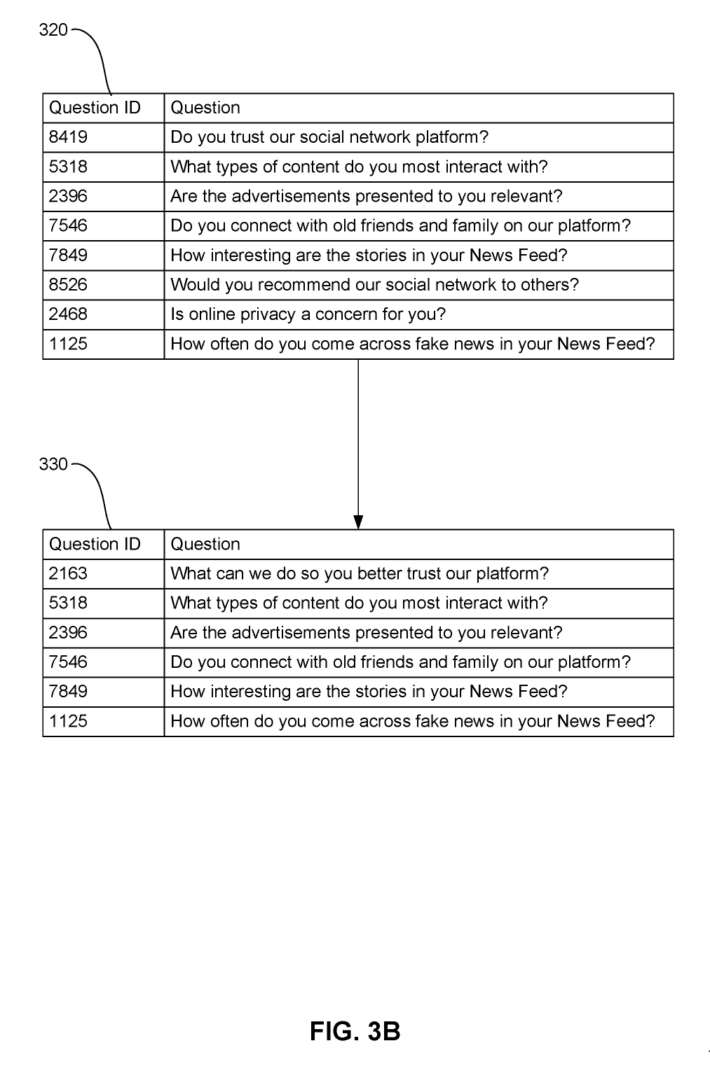

FIG. 3A illustrates a plurality of survey questions 310 and a first subset of survey questions 320, according to some embodiments. The plurality of survey questions 310 may be obtained from the survey information database 220, as described above. Each question of the plurality of survey questions 310 may be associated with a question ID. The question IDs may be stored in the survey information database 220 along with the survey questions.

The questions shown in the plurality of survey questions 310 may be questioned accessed from the survey information database 220 by the prediction subsystem 206. In this example, the following questions make up the plurality of survey questions 310:

| Question | |
|---|---|
| ID | Question |
| 3262 | How old are you? |
| 8946 | What gender are you? |
| 5318 | What types of content do you most interact with? |
| 8419 | Do you trust our social network platform? |
| 2396 | Are the advertisements presented to you relevant? |
| 7546 | Do you connect with old friends and family on our platform? |
| 3108 | Do you follow businesses of interest on our platform? |
| 7849 | How interesting are the stories in your News Feed? |
| 8526 | Would you recommend our social network to others? |
| 2468 | Is online privacy a concern for you? |
| 1125 | How often do you come across fake news in your News Feed? |
| 4492 | What device do you use most often with the social network? |

As described above, after the prediction subsystem 206 accesses the questions from the survey information database 220, the question selector subsystem 208 may select a first subset of questions 320 from the plurality of survey questions 310 based on predicted responses and associated certainty scores for the predicted responses determined by the survey optimization model 216. The first subset of questions may exclude at least one question from the plurality of survey questions 310. In this example, the questions labeled with question IDs 3262, 8946, 3108, and 4492 are excluded from the plurality of survey questions 310 in the first subset of questions 320. These questions may be excluded from the plurality of survey questions 310 in the first subset of questions 320 because the survey optimization model 216 may have predicted the responses to these questions by the survey target and the associated certainty scores may be high (low ±value). The first subset of questions includes the following questions:

| Question | |
|---|---|
| ID | Question |
| 5318 | What types of content do you most interact with? |
| 8419 | Do you trust our social network platform? |
| 2396 | Are the advertisements presented to you relevant? |
| 7546 | Do you connect with old friends and family on our platform? |
| 7849 | How interesting are the stories in your News Feed? |
| 8526 | Would you recommend our social network to others? |
| 2468 | Is online privacy a concern for you? |
| 1125 | How often do you come across fake news in your News Feed? |

The question asking the survey target “How old are you?” (Question ID 3262) has been removed from the plurality of survey questions 310 in the first subset of questions 320 because the survey optimization model 216 may be able to predict the survey response based on inputs (e.g., the user's age known by the social networking platform) provided to the model based on data in the user information database 218. The question asking the survey target “What gender are you?” (Question ID 8946) has been removed from the plurality of survey questions 310 in the first subset of questions 320 because the survey optimization model 216 may be able to predict the survey response based on inputs (e.g., the user's age gender by the social networking platform) provided to the model based on data in the user information database 218. The question asking the survey target “Do you follow businesses of interest on our platform?” (Question ID 3108) has been removed from the plurality of survey questions 310 in the first subset of questions 320 because the survey optimization model 216 may be able to predict the survey response based on inputs (e.g., knowledge of the business pages the user follows known by the social networking platform) provided to the model based on data in the user information database 218. The question asking the survey target “What device do you use most often with the social network?” (Question ID 3108) has been removed from the plurality of survey questions 310 in the first subset of questions 320 because the survey optimization model 216 may be able to predict the survey response based on inputs (e.g., knowledge of which device the user most frequently uses to access the social network known by the social networking platform) provided to the model based on data in the user information database 218.

By excluding the above questions from the first subset of questions 320, due to the survey optimization model 216 predicting the survey responses to these questions with associated high certainty scores (low ±value), the survey target may not be asked questions for which the survey target's response would not provide any further valuable information to the social networking platform. Additionally, the survey target's experience with the survey will be improved by not being overwhelmed with extra questions, and the survey target may be more likely to complete the survey and respond to survey questions that the social networking platform can actually gain valuable information from.

FIG. 3B illustrates a first subset of questions 320 and a second subset of questions 330, according to some embodiments. As described above, after the question selector subsystem 208 identifies the first subset of questions 320 from the plurality of survey questions 310, a first question from the first subset of questions 320 may be presented to the survey target. Once the survey target provides a survey response to the first question, the model updater subsystem 214 may update the survey optimization model 216 based on the survey response provided by the survey target. The survey optimization model 216 may then be run again, by the controller subsystem 202, to again predict responses to the remaining survey questions. The question selector subsystem 208 may then identify a second subset of questions 330, based on the predicted survey responses and associated certainty scores determined by the second run of the survey optimization model 216. The second subset of questions may exclude one or more questions from the first subset of questions 320 because the survey optimization model 216 may have predicted the responses to these questions by the survey target and the associated certainty scores may be high (low ±value). In some embodiments, the second subset of questions 320 may also include one or more questions that were excluded from the plurality of survey questions 310 when identifying the first subset of questions 320.

Assuming the first question in the survey presented to the survey target from the first subset of questions 310 is “Do you trust our social network platform?” (Question ID 8419), and the survey target responds in the negative (indicating the survey target does not trust the social network platform), the survey target's response may be used to update the survey optimization model 216 and again predict responses and determine certainty scores for the remaining questions. After running the model again and identifying the second subset of questions, the second subset of questions 320 may include the following questions:

| Question | |
|---|---|
| ID | Question |
| 2163 | What can we do so you better trust our platform? |
| 5318 | What types of content do you most interact with? |
| 2396 | Are the advertisements presented to you relevant? |
| 7546 | Do you connect with old friends and family on our platform? |
| 7849 | How interesting are the stories in your News Feed? |
| 1125 | How often do you come across fake news in your News Feed? |

Based on the survey optimizations model's 216 knowledge that the user responded to a question regarding trusting the social network platform in the negative, certain questions from the first subset of questions 320 may now be excluded in the second subset of questions 330. For example, the question asking the survey target “Would you recommend our social network to others?” (Question ID 8526) and the question asking the survey target “Is online privacy a concern for you?” have been removed from the plurality of survey questions 310 in the first subset of questions 320 because, based on the survey target's response to the first question regarding trust of the social network platform, the survey optimization model 216 may be able to predict the survey response to these questions. For example, the survey optimization model 216 may predict that the survey target may respond in the negative to the question “Would you recommend our social network to others?” (Question ID 8526) and may respond in the affirmative to the question “Is online privacy a concern for you?” (Question ID 2468). Presenting these two questions to the survey target would likely not provide any additional valuable information to the social networking platform, and thus may be excluded.

In addition, the second subset of questions 330 may include a new question that was not originally included in the plurality of survey questions 310 or the first subset of questions 320. For example, the second subset of questions 330 may include a question asking the survey target “What can we do so you better trust our platform?” (Question ID 2163). This question may be presented to the survey target based on the survey target's negative response regarding trust of the social networking platform.

This process may repeat after each survey response provided by the survey target, so that the survey optimization model operates in a “feedback loop” and gets updated after each provided survey response. The process may end when the controller subsystem 202 determines that there are no more questions to present to the survey target. As illustrated, the survey questions may adjust after each provided survey response, and the subsequently presented survey questions may change, be newly added, or be removed based on responses to the previous questions.

### Software as a Service (SaaS) Model

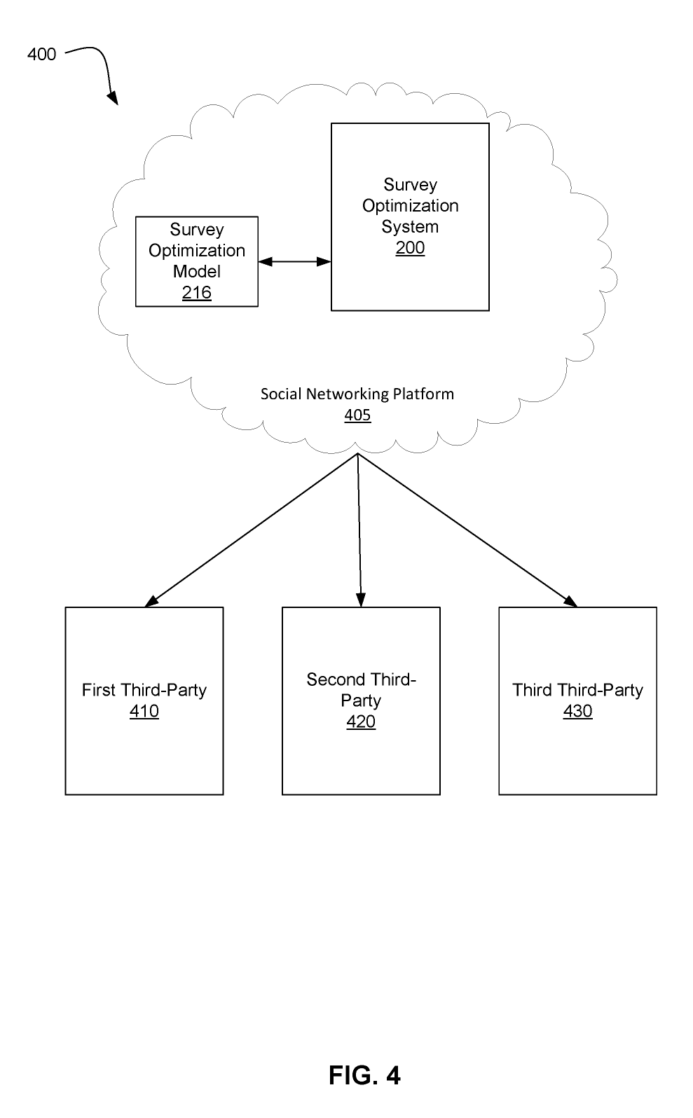

FIG. 4 is a block diagram illustrating the survey optimization system 200 implemented in a Software as a Service (SaaS) model 400. In some embodiments, the functionality of the survey optimization system 200 may be offered to third-parties within a Software as a Service (SaaS) model 400. In the SaaS model 400, the social networking platform, which may include the survey optimization system 200, may interface with one or more third-parties. For example, the social networking platform 405 may interface with a first third-party 410, second third-party 420, and third third-party 430. Each of the third-parties may be third-party service providers. For example, a third-party could provide a news service, a gaming service, an e-mail service, etc. Regardless of the service(s) provided by the third-parties, a third-party may be gain the benefit of the functionality of the survey optimization system 200 in administering their own surveys.

For example, the first third-party 410 may determine that a user of their service is eligible for a survey. This user may then become a survey target and the first third-party 410 may transit information identifying the survey target and information pertaining to the survey questions to the survey optimization system 200 via the social networking platform 405. According to the embodiments described above, the survey optimization system 200 may then predict responses to the survey questions and determine associated certainty scores with the predictions based on information pertaining to the survey target known by the social networking platform 405 and stored in the user information database 218. The survey optimization system 200 may then transmit, via the social networking platform 405, the predicted responses and associated certainty scores to the first third-party 410. The first third-party 410 may use this information to optimize their own survey questions and decide whether to exclude any questions from the survey presented to the survey target.

An advantage of this implementation is that the social networking platform 405 may keep the data in the user information database 218 safe and inaccessible by the third-parties, while still providing the benefits of the survey optimization model 216 to the third-parties such that they can improve their own surveys provided to survey targets. The third-parties may not be able to obtain any user specific information stored in the user information database 218, and may only receive predicted responses and certainty scores associated with the predictions for a plurality of survey questions.

### Opt-In and Opt-Out

It should be noted that in any of the above embodiments, a user or survey target may have the option to “opt-in” or “opt-out” of the survey optimization system 200. The social networking platform and the survey optimization system 200 may honor user privacy and treat it with the utmost importance. In some embodiments, a user or survey target may be required to actively “opt-in” to the survey optimization system 200 before any user information and response data is stored by the survey optimization system 200. Similarly, a user or survey target may “opt-out” at any time such that the user or survey target's information and user data is deleted from the survey optimization system 200. In some embodiments, the survey optimization system 200 may delete or “throw-away” information pertaining to the user or survey target's provided survey response to a survey question after the survey response is used by the model updater subsystem 214 to update the survey optimization model 216.

### Exemplary Computing System

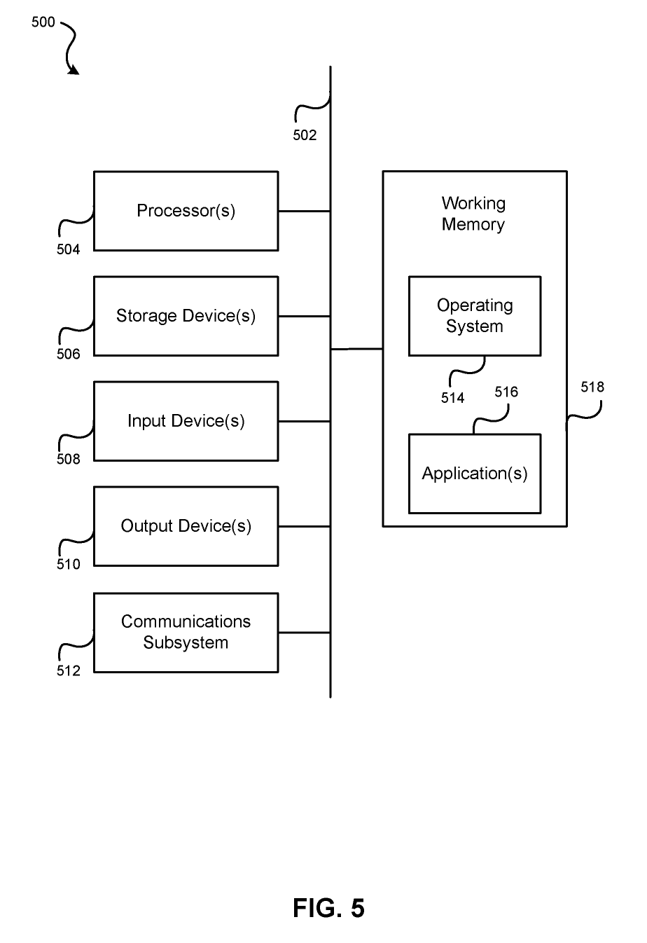

FIG. 5 illustrates an example of a computing system in which one or more embodiments may be implemented.

A computer system as illustrated in FIG. 5 may be incorporated as part of the above described computerized device. For example, computer system 500 can represent some of the components of a television, a computing device, a server, a desktop, a workstation, a control or interaction system in an automobile, a tablet, a netbook or any other suitable computing system. A computing device may be any computing device with an image capture device or input sensory unit and a user output device. An image capture device or input sensory unit may be a camera device. A user output device may be a display unit. Examples of a computing device include but are not limited to video game consoles, tablets, smart phones and any other hand-held devices. FIG. 5 provides a schematic illustration of one embodiment of a computer system 500 that can perform the methods provided by various other embodiments, as described herein, and/or can function as the host computer system, a remote kiosk/terminal, a point-of-sale device, a telephonic or navigation or multimedia interface in an automobile, a computing device, a set-top box, a table computer and/or a computer system. FIG. 5 is meant only to provide a generalized illustration of various components, any or all of which may be utilized as appropriate. FIG. 5, therefore, broadly illustrates how individual system elements may be implemented in a relatively separated or relatively more integrated manner. In some embodiments, elements computer system 500 may be used to implement functionality of the survey optimization 200 in FIG. 2.

The computer system 500 is shown comprising hardware elements that can be electrically coupled via a bus 502 (or may otherwise be in communication, as appropriate). The hardware elements may include one or more processors 504, including without limitation one or more general-purpose processors and/or one or more special-purpose processors (such as digital signal processing chips, graphics acceleration processors, and/or the like); one or more input devices 508, which can include without limitation one or more cameras, sensors, a mouse, a keyboard, a microphone configured to detect ultrasound or other sounds, and/or the like; and one or more output devices 510, which can include without limitation a display unit such as the device used in embodiments of the invention, a printer and/or the like.

In some implementations of the embodiments of the invention, various input devices 508 and output devices 510 may be embedded into interfaces such as display devices, tables, floors, walls, and window screens. Furthermore, input devices 508 and output devices 510 coupled to the processors may form multi-dimensional tracking systems.

The computer system 500 may further include (and/or be in communication with) one or more non-transitory storage devices 506, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data storage, including without limitation, various file systems, database structures, and/or the like.

The computer system 500 might also include a communications subsystem 512, which can include without limitation a modem, a network card (wireless or wired), an infrared communication device, a wireless communication device and/or chipset (such as a Bluetooth™ device, an 802.11 device, a Wi-Fi device, a WiMax device, cellular communication facilities, etc.), and/or the like. The communications subsystem 512 may permit data to be exchanged with a network, other computer systems, and/or any other devices described herein. In many embodiments, the computer system 500 will further comprise a non-transitory working memory 518, which can include a RAM or ROM device, as described above.

The computer system 500 also can comprise software elements, shown as being currently located within the working memory 518, including an operating system 514, device drivers, executable libraries, and/or other code, such as one or more application programs 516, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 506 described above. In some cases, the storage medium might be incorporated within a computer system, such as computer system 500. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed. In some embodiments, one or more elements of the computer system 500 may be omitted or may be implemented separate from the illustrated system. For example, the processor 504 and/or other elements may be implemented separate from the input device 508. In one embodiment, the processor is configured to receive images from one or more cameras that are separately implemented. In some embodiments, elements in addition to those illustrated in FIG. 5 may be included in the computer system 500.

Some embodiments may employ a computer system (such as the computer system 500) to perform methods in accordance with the disclosure. For example, some or all of the procedures of the described methods may be performed by the computer system 500 in response to processor 504 executing one or more sequences of one or more instructions (which might be incorporated into the operating system 514 and/or other code, such as an application program 516) contained in the working memory 518. Such instructions may be read into the working memory 518 from another computer-readable medium, such as one or more of the storage device(s) 506. Merely by way of example, execution of the sequences of instructions contained in the working memory 518 might cause the processor(s) 504 to perform one or more procedures of the methods described herein.

The terms “machine-readable medium” and “computer-readable medium,” as used herein, refer to any medium that participates in providing data that causes a machine to operate in a specific fashion. In some embodiments implemented using the computer system 500, various computer-readable media might be involved in providing instructions/code to processor(s) 504 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 506. Volatile media include, without limitation, dynamic memory, such as the working memory 518. Transmission media include, without limitation, coaxial cables, copper wire and fiber optics, including the wires that comprise the bus 502, as well as the various components of the communications subsystem 512 (and/or the media by which the communications subsystem 512 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to the processor(s) 504 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 500. These signals, which might be in the form of electromagnetic signals, acoustic signals, optical signals and/or the like, are all examples of carrier waves on which instructions can be encoded, in accordance with various embodiments of the invention.

The communications subsystem 512 (and/or components thereof) generally will receive the signals, and the bus 502 then might carry the signals (and/or the data, instructions, etc. carried by the signals) to the working memory 518, from which the processor(s) 504 retrieves and executes the instructions. The instructions received by the working memory 518 may optionally be stored on a non-transitory storage device 506 either before or after execution by the processor(s) 504.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, some embodiments are described as processes depicted as flow diagrams or block diagrams. Although each may describe the operations as a sequential process, many of the operations can be performed in parallel or concurrently. In addition, the order of the operations may be rearranged. A process may have additional steps not included in the figures. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks. Thus, in the description above, functions or methods that are described as being performed by the computer system may be performed by a processor—for example, the processor 504—configured to perform the functions or methods. Further, such functions or methods may be performed by a processor executing instructions stored on one or more computer readable media.

Having described several embodiments, various modifications, alternative constructions, and equivalents may be used without departing from the spirit of the disclosure. For example, the above elements may merely be a component of a larger system, wherein other rules may take precedence over or otherwise modify the application of the invention. Also, a number of steps may be undertaken before, during, or after the above elements are considered. Accordingly, the above description does not limit the scope of the disclosure.

Various examples have been described. These and other examples are within the scope of the following claims.

What is claimed is:

1. A method, comprising:
determining, by a system comprising one or more processors, for each question in a plurality of questions in a survey, a prediction indicative of a likelihood that a first user will provide a specific answer to the question and a certainty score associated with the prediction;
identifying, by the system, based upon the predictions and the certainty scores determined for the plurality of questions in the survey, a first subset of questions from the plurality of questions in the survey, the identifying comprising excluding one or more questions in the plurality of questions from the first subset of questions; and
presenting, by the system, a first question from the first subset of questions to the first user.

2. The method of claim 1, wherein the excluding the one or more questions in the plurality of questions from the first subset of questions comprises:
determining, based on the prediction and the certainty score determined for a particular question in the plurality of questions, that the particular question is to be excluded from the first subset of questions to be presented to the first user.

3. The method of claim 1, further comprising:
receiving, by the system, a response provided by the first user to the first question; and
in response to the received response, for each question in the plurality of questions that has not been presented to the first user, generating, by the system, an updated prediction indicative of the likelihood that the first user will provide a specific answer to the question and generating an updated certainty score associated with the updated prediction.

4. The method of claim 3, further comprising:
based on the updated predictions and updated certainty scores generated for the questions in the first subset of questions of the plurality of questions that have not been presented to the first user, identifying, by the system, a second subset of questions from the plurality of questions in the survey; and
presenting, by the system, a second question from the second subset of questions to the first user.

5. The method of claim 4, wherein the second subset of questions does not include at least one question from the first subset of questions.

6. The method of claim 4, wherein the one or more questions in the plurality of questions excluded from the first subset of questions is now included in the second subset of questions.

7. The method of claim 1, wherein determining a prediction and an associated certainty score for each question in the plurality of questions in the survey comprises:
using a model to determine the predictions and the associated certainty scores for the plurality of questions in the survey, wherein the model is built based upon information about the first user accessible from a social networking system.

8. The method of claim 7, wherein the model is initially trained using historical data indicative of the first user's response to one or more questions presented to the user prior to the determining step.

9. The method of claim 7, wherein the model is a supervised machine learning model.

10. The method of claim 1, wherein determining the prediction and the certainty score associated with the prediction is based in part on at least one of:
historical data indicative of the first user's response to one or more questions presented to the user prior to the determining step;
information identifying the first user;
demographic information associated with the first user;
information pertaining to the first user's interests; or
information identifying the first user's connections within a social networking system.

11. A system, comprising:
a processor; and
a non-transitory computer readable medium coupled the processor, the computer readable medium comprising code, executable by the processor, for implementing a method comprising:
determining, for each question in a plurality of questions in a survey, a prediction indicative of a likelihood that a first user will provide a specific answer to the question and a certainty score associated with the prediction;
identifying, based upon the predictions and the certainty scores determined for the plurality of questions in the survey, a first subset of questions from the plurality of questions in the survey, the identifying comprising excluding one or more questions in the plurality of questions from the first subset of questions; and
presenting a first question from the first subset of questions to the first user.

12. The system of claim 11, wherein the excluding the one or more questions in the plurality of questions from the first subset of questions comprises:
determining, based on the prediction and the certainty score determined for a particular question in the plurality of questions, that the particular question is to be excluded from the first subset of questions to be presented to the first user.

13. The system of claim 11, further comprising:
receiving, by the system, a response provided by the first user to the first question; and
in response to the received response, for each question in the plurality of questions that has not been presented to the first user, generating, by the system, an updated prediction indicative of the likelihood that the first user will provide a specific answer to the question and generating an updated certainty score associated with the updated prediction.

14. The system of claim 13, further comprising:
based on the updated predictions and updated certainty scores generated for the questions in the first subset of questions of the plurality of questions that have not been presented to the first user, identifying, by the system, a second subset of questions from the plurality of questions in the survey; and
presenting, by the system, a second question from the second subset of questions to the first user.

15. The system of claim 14, wherein the second subset of questions does not include at least one question from the first subset of questions.

16. The system of claim 14, wherein the one or more questions in the plurality of questions excluded from the first subset of questions is now included in the second subset of questions.

17. The system of claim 11, wherein determining a prediction and an associated certainty score for each question in the plurality of questions in the survey comprises:
using a model to determine the predictions and the associated certainty scores for the plurality of questions in the survey, wherein the model is built based upon information about the first user accessible from a social networking system.

18. The system of claim 17, wherein the model is initially trained using historical data indicative of the first user's response to one or more questions presented to the user prior to the determining step.

19. The system of claim 11, wherein determining the prediction and the certainty score associated with the prediction is based in part on at least one of:
historical data indicative of the first user's response to one or more questions presented to the user prior to the determining step;
information identifying the first user;
demographic information associated with the first user;
information pertaining to the first user's interests; or
information identifying the first user's connections within a social networking system.

20. One or more non-transitory computer-readable media storing computer-executable instructions that, when executed, cause one or more computing devices to:
determine, for each question in a plurality of questions in a survey, a prediction indicative of a likelihood that a first user will provide a specific answer to the question and a certainty score associated with the prediction;
identify, based upon the predictions and the certainty scores determined for the plurality of questions in the survey, a first subset of questions from the plurality of questions in the survey, the identifying comprising excluding one or more questions in the plurality of questions from the first subset of questions; and
present, a first question from the first subset of questions to the first user.
